(19) United States
(12) Patent Application Publication
(10) Pub. No.: US 2007/0008919 A1
(43) Pub. Date: Jan. 11, 2007

(54) Value added services system of wireless local area network and method for providing the same

(75) Inventors: Chaucer Chiu, Taipei (TW); Clark Yu, Taipei (TW)

Correspondence Address: EDWARDS & ANGELL, LLP, P.O. BOX 55874, BOSTON, MA, 02205, US

(73) Assignee: Inventec Corporation, Taipei (TW)

(21) Appl. No.: 11/286,842

(22) Filed: Nov. 22, 2005

(30) Foreign Application Priority Data
Jul. 11, 2005 (TW) 094123328

(51) Int. Cl. H04Q 7/00

(52) U.S. Cl. 370/328; 709/206

(57) ABSTRACT

A Value Added Services (VAS) system of Wireless Local Area Network (WLAN) and a method for providing the same which are applied in a wireless mobile communication device are proposed for allowing a user to use a plurality of VAS provided by a wireless mobile communication provider through the wireless mobile communication device. A WLAN receives and confirms a connecting information outputted from the wireless mobile communication device by the user, then the WLAN outputs a connection-permission information to a workstation after being connected to the wireless mobile communication device, and the workstation provides a plurality of VAS to the user through the WLAN. Therefore, the wireless mobile communication provider can autonomously customize and manage the VAS in accordance with the practical requirements of the user, so that the network resources can be used more effectively.

### FIELD OF THE INVENTION

The present invention relates to value added services (VAS) systems of Wireless Local Area Network (WLAN) and methods for providing the same, and more particularly, to a VAS system of WLAN and a method for providing the same for being applied in a wireless mobile communication device.

### BACKGROUND OF THE INVENTION

Wireless Local Area Network (WLAN) is a network structure which can be deployed in a campus, airport, hotel, scenic spot and the like. Compared with wired network structure, the WLAN has an advantage in communication with a network system and using all resources therein without Lines of Communication (LOC). Generally, a network range covered by a WLAN is based on its surroundings. For example, the distance of the network range is about 250 m without extension of antenna, the distance may be about 35 m to 50 m if the area is half-opened with some hindrances, and the distance certainly may be farther with the extension of antenna. Users may use wireless communication networks largely for convenience with the development of related techniques and protocols in network. As to a usual application of the wireless communication network, only a wireless network card is required in a Personal Computer (PC) or a handheld device with WLAN interface and an Access Point (AP) is equipped in an area, the network connection can be maintained at any moment in this area.

However, there is not yet a WLAN network infrastructure that integrates a plurality of Value Added Services (VAS) and applied in notebook computers and Personal Digital Assistants (PDAs) besides the functions for browsing Internet information and accessing E-mails.

Currently cell phones incorporating VAS are provided by Internet Service Providers (ISPs). It means that a user must dial up connection to an ISP host in order to gain access to the Internet and connect to an Internet company which provides various VAS related to the Internet, wherein the VAS mainly include Internet dial-up accounts, special-line accounts, E-mail accounts, virtual hosts, application of Domain Names, design and maintenance of web pages and so on.

Many modems with function of automatic response are usually provided in an ISP equipment room and connected to terminal servers for providing connection services to users. Additionally, most ISPs have web page servers, E-mail servers and routers for outside connection and the like.

As to the current connection method of a cell phone incorporating the VAS, users must apply to a telecom provider or an ISP company for connecting to a network system so as to use the VAS provided by the telecom provider or the ISP company. However, the connecting rate, service quality and cost of various providers are different.

Accordingly, as the current VAS of a cell phone are provided by a network structure which is set up by a telecom provider or an ISP company, not only network resource is limited to a user, but also the VAS provided by a telecom provider is limited. That is to say, the VAS provided by the telecom provider or the ISP company are not useful for users with different requirements, thus there is no autonomous selection for ISP, and the VAS not required by users may also produce waste of resource.

Moreover, it is still not convenient for users or managers because ISP are in different geographic positions.

As a result, the present subject to be solved in this art is to provide a VAS system of a cell phone by which a telecom provider can customize and easily manage the VAS by oneself in accordance with user requirements.

### SUMMARY OF THE INVENTION

In light of the above prior-art drawbacks, a primary objective of the present invention is to provide a Value Added Services (VAS) system of Wireless Local Area Network (WLAN) and a method for providing the same, by which a wireless mobile communication provider can autonomously customize and manage the VAS.

Another objective of the present invention is to provide a VAS system of WLAN and a method for providing the same, which can accord with requirements of users and avoid the waste of network resources.

In accordance with the above and other objectives, the present invention proposes a VAS system of WLAN which is applied in a wireless mobile communication device for allowing a user to use a plurality of VAS provided by a wireless mobile communication provider through the wireless mobile communication device. The system comprises a WLAN which is used to receive and confirm a connecting information from the wireless mobile communication device of the user, and then output a connection-permission information after connecting to the wireless mobile communication device; and a workstation which is used to receive the connection-permission information from the WLAN and provide a plurality of VAS to the user through the WLAN.

According to the VAS system of WLAN, the present invention further proposes a method for providing VAS of WLAN which comprises receiving a connecting information by a WLAN through the wireless mobile communication device of the user; the WLAN connecting to the wireless mobile communication device after confirming the connecting information, then outputting a connection-permission information to a workstation; and providing a plurality of VAS to the user through the WLAN by the workstation.

Compared with the prior art, the present invention enables the wireless mobile communication provider to autonomously customize and manage the VAS, so the abovementioned primary and other objectives can be attained.

### BRIEF DESCRIPTION OF THE DRAWINGS

FIG. 1 is a block diagram showing a basic structure of the Value Added Services (VAS) system of Wireless Local Area Network (WLAN) incorporating a user end according the present invention;

FIG. 2 is a block diagram showing a detailed system structure of the VAS system of WLAN incorporating a user end according the present invention;

FIG. 3 is a block diagram showing an embodiment of the VAS system of WLAN incorporating a user end according the present invention;

FIG. 4 is a flow chart showing basic processing steps of the method for providing VAS of WLAN according the present invention; and

FIG. 5 is a flow chart showing detailed processing steps of a method for providing VAS of WLAN according the present invention.

### DISCLOSURE OF THE INVENTION

The present invention is described by the following specific embodiments. Those with ordinary skills in the arts can readily understand the other advantages and functions of the present invention after reading the disclosure of this specification. The present invention can also be implemented with different embodiments. Various details described in this specification can be modified based on different viewpoints and applications without departing from the scope of the present invention.

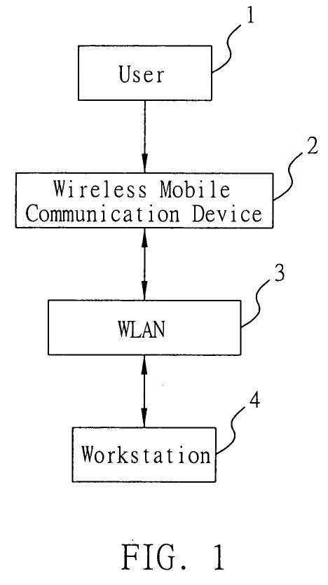

FIG. 1 to FIG. 5 are relevant drawings showing a Value Added Services (VAS) system of wireless local area network (WLAN) and a method for providing the same according to the present invention. Detailed descriptions in conjunction with these drawings will be set forth for illustrating preferred embodiments of the VAS system of WLAN and the method for providing the same according to the present invention. It should be noted that these drawings are made in simplicity just for describing the basic structure and process steps, thereby only associated components and numbers are shown in the drawings and can be modified in accordance with different embodiments.

FIG. 1 shows a basic system structure of a VAS system of WLAN incorporating a user end according the present invention. The present invention is applied to a wireless mobile communication device 2 shown in the drawing, through which a user 1 is able to use a plurality of VAS provided by a wireless mobile communication provider, wherein, the wireless mobile communication device 2 supports WLAN and preferably may be one of a cell phone, Personal Digital Assistant (PDA), notebook computer, and Wireless Fidelity (WiFi) Tag with a wireless network card and other devices having the WLAN communication function. The VAS system of WLAN of the present invention comprises a WLAN 3 for transmitting information and a workstation for transmitting VAS information.

The above WLAN 3 is used to receive a connecting information from the wireless mobile communication device 2 by the user 1, and output a connection-permission information after confirming the connecting information and establishing a connection to the wireless mobile communication device 2. The WLAN 3 includes at least one wireless base station which preferably may be an Access Point (AP).

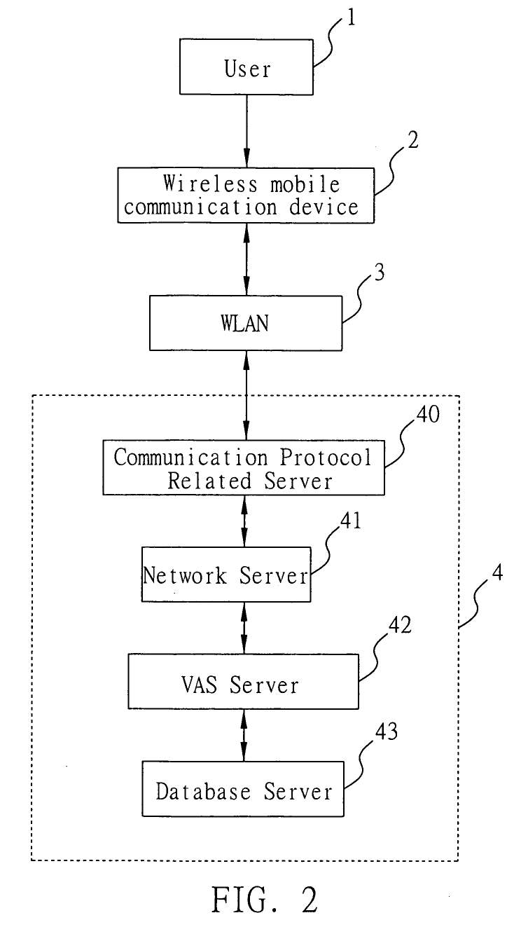

The above workstation 4 is used to receive the connection-permission information from the WLAN 3 and provide a plurality of VAS to the user 1 through the WLAN 3. In conjunction with FIG. 2, the workstation includes a communication protocol related server 40 for receiving the connection-permission information from the WLAN 3 and transferring the connection-permission information; a network server 41 for receiving the connection-permission information from the communication protocol related server 40 and outputting a login-permission information after a verifying mechanism verifies the connection-permission information; a VAS server 42 for receiving the login-permission information from the network server 41 and transmitting VAS information provided by the VAS server 42 back to the wireless mobile communication device 2 of the user 1 through the WLAN 3; and a database server 43 for storing the data related to the VAS information provided by the VAS server 42. The verifying mechanism allows the user 1 to input related data for using the VAS. The related data provided by the wireless mobile communication provider includes a set of user name and password.

The communication protocol related server 40 is a Wireless Application Protocol (WAP) related server.

The network server 41 is a WLAN server.

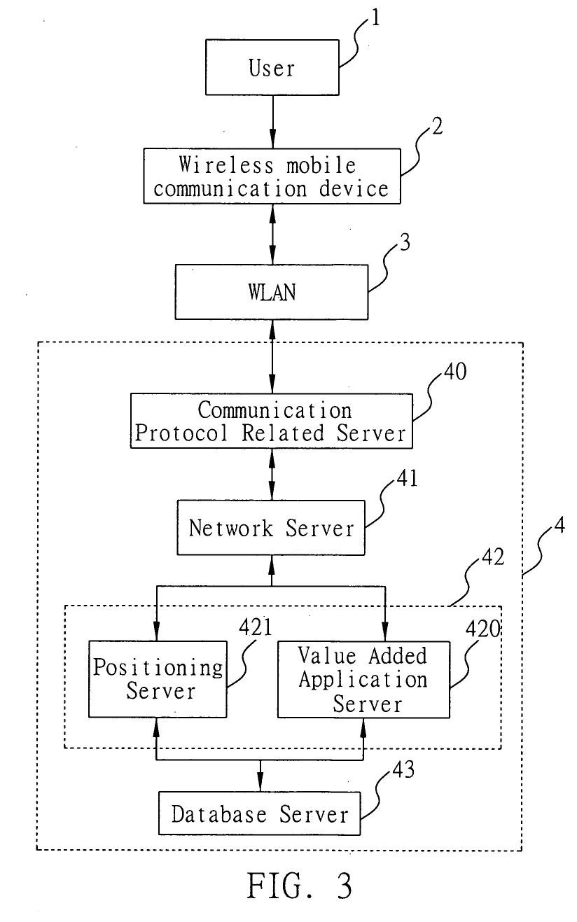

In FIG. 3, it shows an embodiment of the above VAS server 42. The VAS server 42 may be a value added application server 420 or a positioning server 421, alternatively may comprise both a value added application server 420 and a positioning server 421. The amount and content of the value added application servers 420 and positioning servers 421 are customized by a manager, i.e. the wireless mobile communication provider can customize and manage the VAS by his/her own needs or the user's need. The positioning server 421 preferably determines the location of the wireless mobile communication device 2 according to an Internet Protocol (IP) Address of the wireless mobile communication device 2 and the IP Address is configured by a Dynamic Host Configuration Protocol (DHCP) of a DHCP host of the WLAN 3. That is to say, in the WLAN standard, since that the APs automatically configure IP addresses for terminal devices (e.g. the wireless mobile communication device 2 of this embodiment) according to DHCP and IP addresses allocated by any two APs will not share the same address range, thus the positioning server 421 can determine the AP in which a terminal device currently exists according to the IP address of the terminal device. Accordingly, when a mobile communication device with WLAN (for example, a cell phone) logs in a WLAN positioning service website, the positioning server 421 can determine the current location of the cell phone according to its IP address. Furthermore, increasing distribution density of the APs can raise the positioning accuracy such that a more accurate position can be determined.

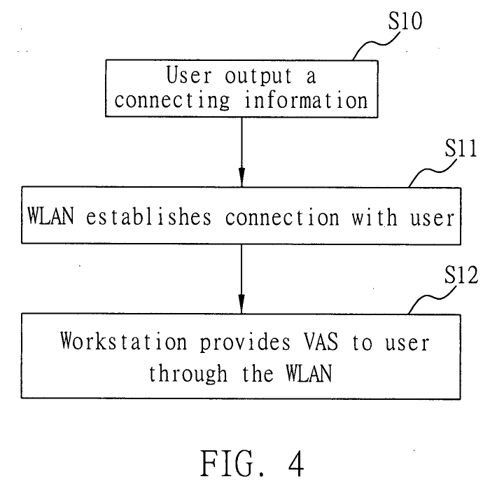

According to the VAS system of WLAN, the present invention further proposes a method for providing VAS of WLAN. FIG. 4 shows basic processing steps of the method for providing VAS of WLAN according to the present invention. The method is applied in a wireless mobile communication device for allowing a user to use a plurality of VAS provided by a wireless mobile communication provider through the wireless mobile communication device. First perform step S10.

In step S10, the user outputs a connecting information. In particular, the user outputs a connecting information to a WLAN through the wireless mobile communication device. Then go to step S11.

In step S11, connection between the user and the WLAN is set up. In particular, the WLAN outputs a connection-permission information after confirming the connecting information and connecting to the wireless mobile communication device. Then go to step S12.

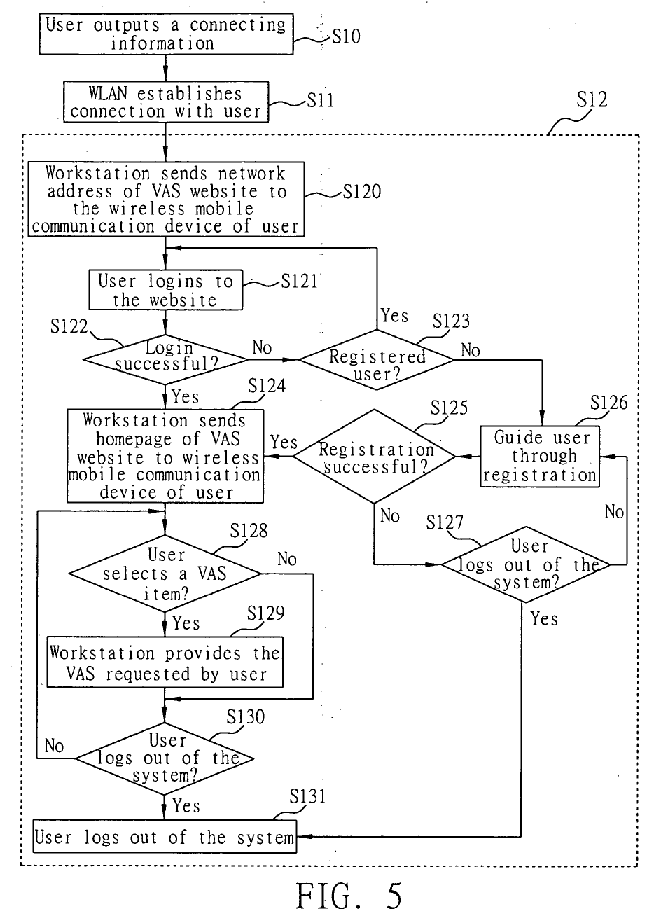

In step S12, a workstation provides VAS to the user through the WLAN. In particular, the workstation receives the connection-permission information from the WLAN and provides a plurality of VAS to the user through the WLAN. FIG. 5 further describes the detailed processes of step S12, i.e. after the WLAN connects to the wireless mobile communication device, go to step S120.

In step S120, the workstation transmits a network address of a website of the VAS to the wireless mobile communication device of the user. Then proceed to step S121.

In step S121, the user logs in the website of the VAS displayed on the screen of the wireless mobile communication device. Then go to step S122.

In step S122, if the user logs in successfully, then go to step S124, otherwise go to step S123.

Step S123 informs the user a login failure. In this step, if tile user is a registered user, then go back to step S121 for the user to log in again, otherwise go to step S126 for the user to register. As shown in step S125, if the register is successful then go to step S124, otherwise go to step S127 for judging whether the user logs out, if the answer is yes, go to step S131 for logging out, otherwise go back to step S126 for the user to register again.

In step S124, since the user logs in or registers successfully, thus the workstation transmits the home page of the VAS to the wireless mobile communication device of the user. Then go to step S128.

In step S128, if the user has selected a VAS item on the homepage of the VAS through the wireless mobile communication device, go to step S129, otherwise go to step S130.

In step S129, the workstation provides the VAS according to the VAS item on the homepage of the VAS selected by the user through the wireless mobile communication device.

In step S130, if the user logs out, then go to step S131 for logging out, otherwise go back to step S128 for judging whether the user has selected a VAS item on the homepage of the VAS through the wireless mobile communication device. However, the components mentioned in the present method for providing VAS of WLAN are tile same as those in the foregoing system.

The technical characteristics and disclosure of the present invention can be understood clearly by the above descriptions and drawings. In particular, a WLAN receives and confirms a connecting information from a wireless mobile communication device of a user, and outputs a connection-permission information to a workstation after connecting to the wireless mobile communication device; and the workstation provides a plurality of VAS to the user through the WLAN. Accordingly, the wireless mobile communication provider can customize and manage the VAS in accordance with the practical requirements of the user, so that the network resource can be used more effectively. Furthermore, the operation efficiency between the user and the wireless mobile communication provider is raised as the information transmission rate of the WLAN used in the present invention is faster than that of the Internet. Moreover, it is quite convenient to the wireless mobile communication provider for management and maintenance because the WLAN is a regional network and the network coverage is concentrated in the same region. Moreover, utilizing the network coverage of a WLAN for providing VAS has a distinctive geographic characteristic. Additionally, the present invention is applied to a wireless mobile communication provider with established WLAN services, i.e., any provider, as long as having an established WLAN, can provide users within that WLAN with VAS. Whether the WLAN VAS are provided or not is all decided by the wireless mobile communication provider, so monopoly of the market by ISPs may not exist. Accordingly, the wireless mobile communication provider can select and define various VAS contents according to practical requirements. In contrast to the prior art, the present invention is much more advantageous in many aspects, for example, in terms of development cost, cost of network usage, data communication ability, communication rate, communication content, easy application and so on.

The above embodiments are only used to illustrate the principles of the present invention, and they should not be construed as to limit the present invention in any way. The above embodiments can be modified by those with ordinary skills in the arts without departing from the scope of the present invention as defined in the following appended claims.

What is claimed is:

1. A Value Added Services (VAS) system of Wireless Local Area Network (WLAN), applicable in a wireless mobile communication device, for allowing a user to use a plurality of VAS provided by a wireless mobile communication provider through the wireless mobile communication device, the VAS system comprising:
a WLAN for receiving and confirming connecting information outputted from the wireless mobile communication device by the user, and outputting connection-permission information after being connected to the wireless mobile communication device; and
a workstation for receiving the connection-permission information from the WLAN and providing the plurality of VAS to the user through the WLAN.

2. The VAS system of claim 1, wherein the workstation comprises:
a communication protocol related server for receiving the connection-permission information from the WLAN and outputting the received connection-permission information;
a network server for receiving the connection-permission information outputted from the communication protocol related server and outputting login-permission information after the connection-permission information is verified by a verifying mechanism;
a VAS server for receiving the login-permission information outputted from the network server and transmitting VAS information provided by the VAS server back to the wireless mobile communication device of the user through the WLAN; and
a database server for storing related data of the VAS information provided by the VAS server.

3. The VAS system of claim 2, wherein the communication protocol related server is a Wireless Application Protocol (WAP) related server.

4. The VAS system of claim 2, wherein the network server is a WLAN server.

5. The VAS system of claim 2, wherein the verifying mechanism is provided for the user to input related data to use the VAS.

6. The VAS system of claim 5, wherein the related data inputted by the user include a set of user name and password.

7. The VAS system of claim 5, wherein the related data inputted by the user are provided by the wireless mobile communication provider.

8. The VAS system of claim 2, wherein the VAS server is one of a value added application server, a positioning server and a combination thereof.

9. The VAS system of claim 8, wherein the positioning server is for determining a location of the wireless mobile communication device according to an Internet Protocol (IP) address of the wireless mobile communication device.

10. The VAS system of claim 9, wherein the IP address is configured by a Dynamic Host Configuration Protocol (DHCP) of the WLAN.

11. A method for providing Value Added Services (VAS) of Wireless Local Area Network (WLAN), applied in a wireless mobile communication device, for allowing a user to use a plurality of VAS provided by a wireless mobile communication provider through the wireless mobile communication device, the method comprising the steps of:
outputting connecting information to a WLAN through the wireless mobile communication device by the user;
after confirming the connecting information, having the WLAN be connected to the wireless mobile communication device and output connection-permission information; and
having a workstation receive the connection-permission information from the WLAN and provide a plurality of VAS to the user through the WLAN.

12. The method of claim 11, wherein the workstation comprises:
a communication protocol related server for receiving the connection-permission information from the WLAN and outputting the received connection-permission information;
a network server for receiving the connection-permission information outputted from the communication protocol related server and outputting login-permission information after the connection-permission information is verified by a verifying mechanism;
a VAS server for receiving the login-permission information outputted from the network server and transmitting VAS information provided by the VAS server back to the wireless mobile communication device of the user through the WLAN; and
a database server for storing related data of the VAS information provided by the VAS server.

13. The method of claim 12, wherein the communication protocol related server is a WAP related server.

14. The method of claim 12, wherein the network server is a WLAN server.

15. The method of claim 12, wherein the verifying mechanism is provided for the user to input related data to use the VAS.

16. The method of claim 15, wherein the related data inputted by the user include a set of user name and password.

17. The method of claim 15, wherein the related data inputted by the user are provided by the wireless mobile communication provider.

18. The method of claim 12, wherein the VAS server is one of a value added application server, a positioning server and a combination thereof.

19. The method of claim 18, wherein the positioning server is for determining a location of the wireless mobile communication device according to an Internet Protocol (IP) address of the wireless mobile communication device.

20. The method of claim 19, wherein the IP address is configured by a Dynamic Host Configuration Protocol (DHCP) of the WLAN.
